(19) United States
(12) Patent Application Publication
(10) Pub. No.: US 2015/0222126 A1
(43) Pub. Date: Aug. 6, 2015

(54) EXTERNAL OR INTERNAL RECEIVER FOR SMART MOBILE DEVICES

(71) Applicant: Energous, Pleasanton, CA (US)

(72) Inventors: Michael A. Leabman, Pleasanton, CA (US); Gregory Scott Brewer, Livermore, CA (US)

(73) Assignee: Energous, Pleasanton, CA (US)

(21) Appl. No.: 14/173,936

(22) Filed: Feb. 6, 2014

(51) Int. Cl. H02J 5/00; H02J 7/00; H02J 7/02

(52) U.S. Cl. CPC H02J 5/005; H02J 7/025; H02J 7/007; H02J 2007/0096

(57) ABSTRACT

The present disclosure may provide a receiver configuration and application, which may be used to provide wireless power transmission for smart mobile devices. Specifically, the receiver may include a plurality of antenna elements connected to at least one rectifier and one power converter. Additionally, the antenna elements may be arranged around the internal edge of any suitable smart mobile device, and antenna elements may include an optimal spacing to provide a better reception, efficiency, and performance of wireless power transmission. Moreover, the disclosed receiver may be used as an internal or external hardware in smart mobile devices.

### CROSS-REFERENCES TO RELATED APPLICATIONS

The present disclosure relates to electronic receivers and more particularly to receivers for wireless power transmission in smart mobile devices.

The present disclosure is related to U.S. non-provisional patent application Ser. No. 13/891,430, filed May 10, 2013, entitled “Methodology for Pocket-forming”; Ser. No. 13/925,469 filed Jun. 24, 2013, entitled “Methodology for Multiple Pocket-Forming”; Ser. No. 13/946,082, filed Jul. 19, 2013, entitled “Method for 3 Dimensional Pocket-forming”; Ser. No. 13/891,399, filed Jul. 22, 2013, entitled “Receivers for Wireless Power Transmission”; and Ser. No. 13/891,445. filed Jul. 22, 2013, entitled “Transmitters for Wireless Power Transmission”.

### FIELD OF INVENTION

The present disclosure relates to electronic receivers and more particularly to receivers for wireless power transmission in smart mobile devices.

### BACKGROUND OF THE INVENTION

Electronic devices such as laptop computers, smartphones, portable gaming devices, tablets and so forth may require power for performing their intended functions. This may require having to charge electronic equipment at least once a day, or in high-demand electronic devices more than once a day. Such an activity may be tedious and may represent a burden to users. For example, a user may be required to carry chargers in case his electronic equipment is lacking power.

In addition, users have to find available power sources to connect to. Lastly, users must plugin to a wall or other power supply to be able to charge his or her electronic device. However, such an activity may render electronic devices inoperable during charging. Current solutions to this problem may include inductive pads which may employ magnetic induction or resonating coils. Nevertheless, such a solution may still require that electronic devices may have to be placed in a specific place for powering. Thus, electronic devices during charging may not be portable.

For the foregoing reasons, there is a need for a wireless power transmission system where electronic devices may be powered without requiring extra chargers or plugs, and where the mobility and portability of electronic devices may not be compromised.

### SUMMARY OF THE INVENTION

The present disclosure provides a receiver configuration and application, which may be used externally or internally for wireless power transmission in any suitable smart mobile device, such as smartphones, or tablets. In an embodiment, a receiver may include a plurality of antenna elements that may be connected in parallel, serial, or in combination to a rectifier.

In another embodiment, an internal receiver implementation scheme may be provided, where a receiver may be embedded around the internal edges of any suitable smart mobile device.

In a further embodiment, an external receiver implementation scheme may be provided, where a receiver may be placed on separate hardware (as a cover) and attached, or paste to any suitable smart mobile device.

The receiver configuration provided in the present disclosure, as well as possible implementation schemes may exhibit a better reception, efficiency, and performance of wireless charging, while eliminating the use of wires or pads for charging devices which may require tedious procedures such as plugging to a wall, and may turn devices unusable during charging. In addition, smart mobile devices may require less components as typical wall chargers may not be required. In some cases, even batteries may be eliminated as a device may fully be powered wirelessly.

Numerous other aspects, features and benefits of the present disclosure may be made apparent from the following detailed description taken together with the drawing figures.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 illustrates wireless power transmission using pocket-forming.

FIG. 2 illustrates a component level embodiment for a receiver.

FIG. 3 illustrates an internal hardware used as a receiver and embedded within a smartphone case.

FIG. 4 illustrates external hardware used as a receiver and pasted or otherwise attached to a smartphone cover.

### DETAILED DESCRIPTION OF THE DRAWINGS

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

### DEFINITIONS

“Pocket-forming” may refer to generating two or more RF waves which converge in 3-d space, forming controlled constructive and destructive interference patterns.

“Pockets of energy” may refer to areas or regions of space where energy or power may accumulate in the form of constructive interference patterns of RF waves.

“Null-space” may refer to areas or regions of space where pockets of energy do not form because of destructive interference patterns of RF waves.

“Transmitter” may refer to a device, including a chip which may generate two or more RF signals, at least one RF signal being phase shifted and gain adjusted with respect to other RF signals, substantially all of which pass through one or more RF antenna such that focused RF signals are directed to a target.

“Receiver” may refer to a device which may include at least one antenna, at least one rectifying circuit and at least one power converter for powering or charging an electronic device using RF waves.

“Adaptive pocket-forming” may refer to dynamically adjusting pocket-forming to regulate power on one or more targeted receivers.

### DESCRIPTION OF THE DRAWINGS

In the following detailed description, reference is made to the accompanying drawings, which form a part hereof. In the drawings, which may not be to scale or to proportion, similar symbols typically identify similar components, unless context dictates otherwise. The illustrative embodiments described in the detailed description, drawings and claims, are not meant to be limiting. Other embodiments may be used and/or and other changes may be made without departing from the spirit or scope of the present disclosure.

Wireless Power Transmission Technology

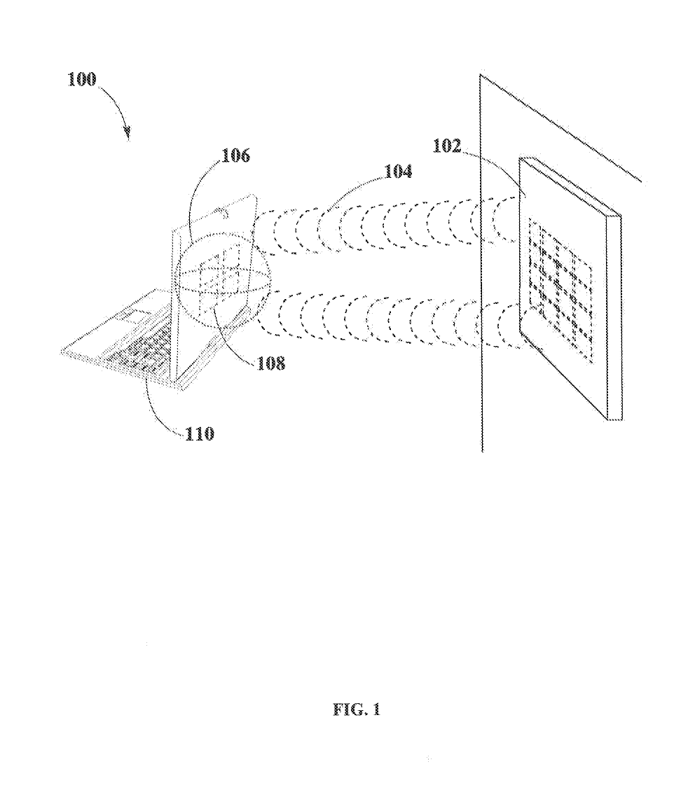

FIG. 1 illustrates wireless power transmission 100 using pocket-forming. More specifically, transmitter 102 may transmit controlled Radio Frequency (RF) waves 104 which may converge in 3-d space. These RF waves may be controlled through phase and/or relative amplitude adjustments to form constructive and destructive interference patterns (pocket-forming). Pockets of energy 106 may form at constructive interference patterns and can be 3-dimensional in shape whereas null-spaces may be generated at destructive interference patterns. A receiver 108 may then utilize pockets of energy 106 produced by pocket-forming for charging or powering an electronic device, for example a laptop computer 110 and thus effectively providing wireless power transmission 100. In some embodiments, there can be multiple transmitters 102 and/or multiple receivers 108 for powering various electronic devices, for example smartphones, tablets, music players, toys and others at the same time. In other embodiments, adaptive pocket-forming may be used to regulate power on electronic devices.

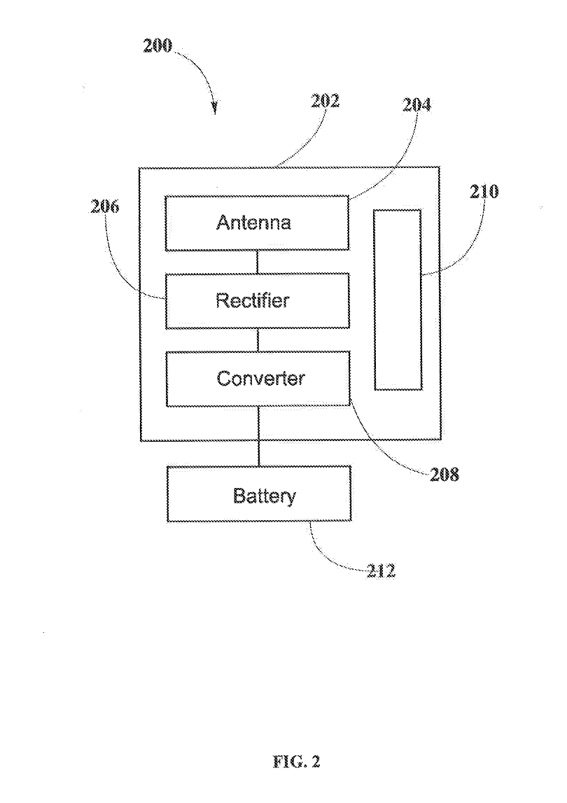

FIG. 2 illustrates a component level embodiment for receiver 200 which can be used for powering or charging an electronic device as exemplified in wireless power transmission 100. Receiver 200 may include housing 202 where at least one antenna element 204, one rectifier 206, one power converter 208 and communications component 210 may be included. Housing 202 can be made of any suitable material which may allow for signal or wave transmission and/or reception, for example plastic or hard rubber. Housing 202 may be external or internal hardware that may be added to different electronic equipment, for example in the form of cases, or can be embedded within electronic equipment as well.

Antenna element 204 may include suitable antenna types for operating in frequency bands similar to the bands described for transmitter 102. Antenna element 204 may include vertical or horizontal polarization, right hand or left hand polarization, elliptical polarization, or other suitable polarizations as well as suitable polarization combinations. Using multiple polarizations can be beneficial in devices where there may not be a preferred orientation during usage or whose orientation may vary continuously through time, for example a smartphone or portable gaming system.

On the contrary, for devices with well-defined orientations, for example a two-handed video game controller, there might be a preferred polarization for antennas which may dictate a ratio for the number of antennas of a given polarization. Suitable antenna types may include patch antennas with heights from about 1/24 inches to about 1 inch and widths from about 1/24 inches to about 1 inch. Patch antennas may have the advantage that polarization may depend on connectivity, i.e. depending on which side the patch is fed, the polarization may change. This may further prove advantageous as a receiver, such as receiver 200, may dynamically modify its antenna polarization to optimize wireless power transmission 100. Rectifier 206 may include diodes or resistors, inductors or capacitors to rectify the alternating current (AC) voltage generated by antenna element 204 to direct current (DC) voltage.

Rectifier 206 may be placed as close as is technically possible to antenna element 204 to minimize losses. After rectifying AC voltage, DC voltage may be regulated using power converter 208. Power converter 208 can be a DC-DC converter which may help provide a constant voltage output, regardless of input, to an electronic device, or as in this embodiment to battery 212. Typical voltage outputs can be from about 5 volts to about 10 volts. In some embodiments, power converter 208 may include electronic switched mode DC-DC converters which can provide high efficiency. In such a case, a capacitor (not shown) may be included before power converter 208 to ensure sufficient current is provided for the switching device to operate.

When charging an electronic device, for example a phone (smartphone) or laptop computer, initial high currents which can break-down the operation of an electronic switched mode DC-DC converter may be required. In such a case, a capacitor (not shown) may be added at the output of receiver 200 to provide the extra energy required. Afterwards, lower power can be provided, for example 1/80 of the total initial power while having the phone or laptop still build-up charge. Lastly, communications component 210, similar to that of transmitter 102 from FIG. 2, may be included in receiver 200 to communicate with transmitter 102 or to other electronic equipment.

Different antenna, rectifier or power converter arrangements are possible for a receiver as will be explained in following embodiments.

Wireless Power Transmission Applications

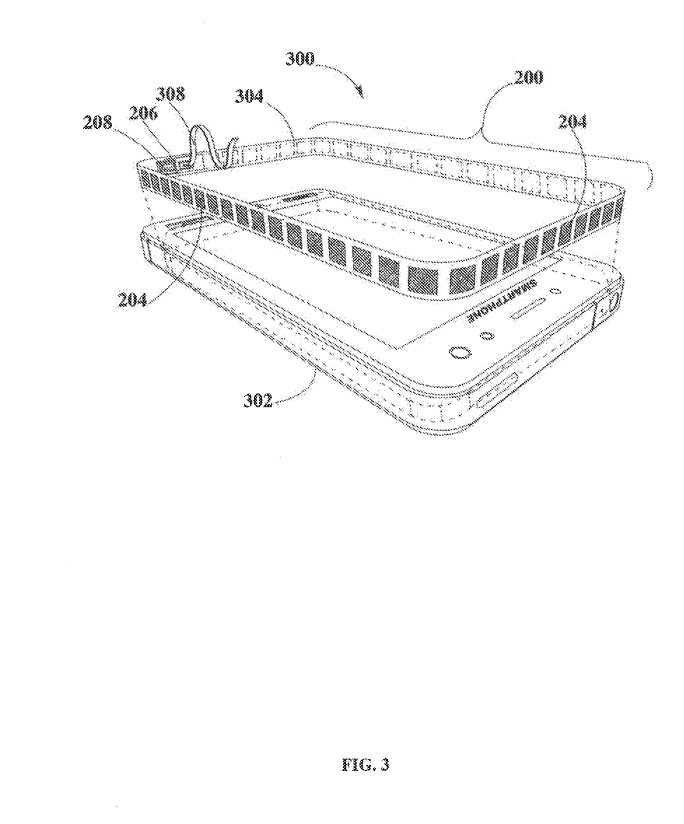

FIG. 3 illustrates internal hardware 300, where receiver 200 may be used for wireless power transmission in smartphones 302. FIG. 3 then shows a first embodiment where smartphone 302 may include receiver 200, as the one described in FIG. 2, embedded around the internal edge of smartphone 302's case. Receiver 200 may include an array of antenna elements 204 strategically distributed on the grid area shown in FIG. 3. The number and type of antenna elements 204 may be calculated according to smartphone 302's design.

Particularly, internal hardware 300 in the form of a printed film 304 or flexible printed circuit board (PCB) may include different components, such as a plurality of printed antenna elements 204 (connected with each other in serial, parallel, or combined), rectifier 206, and power converter 208 elements, as shown in FIG. 2. Printed film 304 may be pasted or otherwise attached to any suitable electronic devices, such as smartphones 302 or tablets and may be connected through any suitable interfaces such as flexible cables 308. Printed film 304 may exhibit some benefits, one of those benefits may be that sections can be cut from it to meet specific smart mobile device sizes and/or requirements.

According to one embodiment, the spacing between antenna elements 204 for receivers 200 may range from about 5 nm to about 12 nm, being most suitable about 7 nm. Additionally, the optimal amount of antenna elements 204 that may be used in receivers 200 for smartphones 302 may be ranging from about 20 to about 30, being most suitable about 25; however, the amount of antennas within receivers 200 may vary according to smartphone 302's design and size. Antenna elements 204 may be made of different conductive materials such as cooper, gold, and silver, among others. Furthermore, antenna elements 204 may be printed, etched, or laminated onto any suitable non-conductive flexible substrate, such as flexible printed circuit board (PCB), among others. The disclosed configuration and orientation of antenna elements 204 may exhibit a better reception, efficiency, and performance of wireless charging.

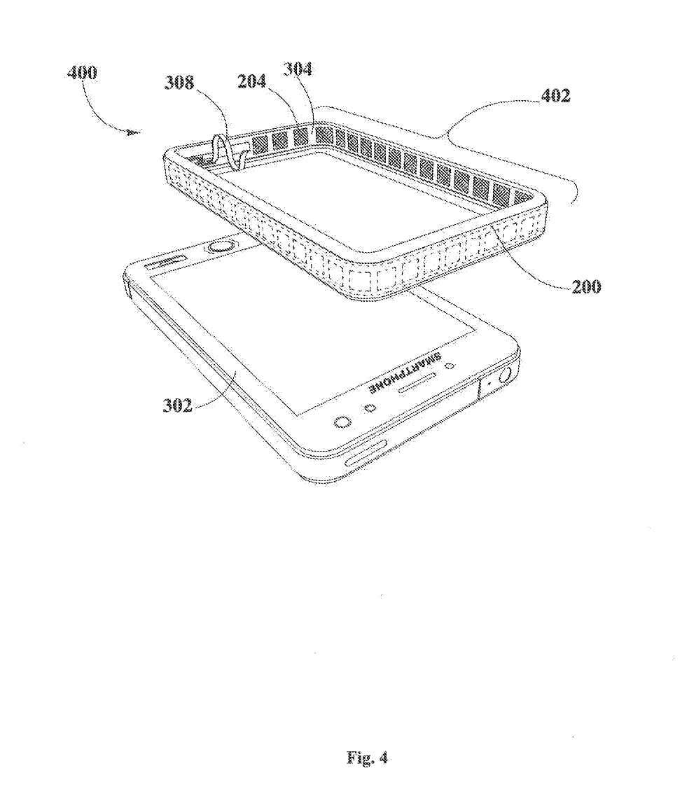

FIG. 4 illustrates external hardware 400 in the form of cover 402 including receiver 200, which may be connected through flexible cables 308 to battery 212 of any suitable smart mobile device, such as smartphones 302. In one embodiment, cover 402 including receiver 200 may be a laptop cover, camera cover, GPS cover, and tablet cover, among other such options.

Furthermore, FIG. 4 shows an embodiment where smartphone 302 may include receiver 200, as the one described in FIG. 2. However, in this embodiment, smartphone 302 may include cover 402 with receiver 200 to provide wireless power to smartphone 302. Cover 402 may be made out of plastic rubber or any other suitable material for covers 402, and may include an array of antenna elements 204 located around the edges of cover 402 for optimal reception. Number, spacing and type of antenna elements 204 may be calculated according to smartphone 302 design and size, as described in FIG. 3.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

Having thus described the invention, We claim:

1. A method for wireless power transmission to a smart mobile device, comprising the steps of:
transmitting power RF waves from a pocket-forming transmitter having a radio frequency integrated circuit, antenna elements, a microprocessor and communication circuitry;
generating pockets of energy from the transmitter to converge in 3-d space at a predetermined location;
integrating a receiver having antenna elements and communication circuitry with the smart mobile device;
converting the pockets of energy from the transmitter to the integrated receiver to power the smart mobile device.

2. The method for wireless power transmission to a smart mobile device of claim 1, wherein the receiver is embedded around an internal edge of the smart mobile device.

3. The method for wireless power transmission to a smart mobile device of claim 1, wherein the antenna elements are distributed on a grid around an internal edge of the smart mobile device.

4. The method for wireless power transmission to a smart mobile device of claim 1, wherein the receiver is embedded around an internal edge of the smart mobile device.

5. The method for wireless power transmission to a smart mobile device of claim 1, wherein the receiver is embedded around an internal edge of the smart mobile device including an array of the antenna elements strategically distributed on a predetermined grid on an outwardly facing surface of the receiver.

6. The method for wireless power transmission to a smart mobile device of claim 1, wherein the receiver antenna elements number and type are calculated according to a smart mobile device configuration.

7. The method for wireless power transmission to a smart mobile device of claim 1, further including the step of connecting an output of the receiver to a battery for the smart mobile device.

8. The method for wireless power transmission to an electronic device from a computer system of claim 1, wherein the receiver is formed on a printed film including printed antenna elements connected in serial, parallel or combination, a rectifier and a power converter and further including the step of pasting the printed film to an internal edge of the smart mobile device.

9. The method for wireless power transmission to a smart mobile device of claim 1, wherein the spacing between receiver antenna elements is approximately 5 mm to 12 mm with 7 mm most suitable for receiving the pockets of energy.

10. The method for wireless power transmission to a smart mobile device of claim 1, wherein the receiver antenna elements are made from conductive materials of copper, silver or gold further including the step of etching or laminating the receiver antenna elements onto a non-conductive flexible substrate band.

11. The method for wireless power transmission to an electronic device from a computer system of claim 1, wherein the receiver is mounted on a peripheral edge cover of a predetermined thickness and circumference conforming to generally an outer edge of the smart mobile device with an array of the antenna elements spaced apart from each other a predetermined distance on an inner surface of the cover.

12. The method for wireless power transmission to a smart mobile device of claim 1, wherein the spacing, type and number of antenna elements located around the edges of the inner surface of the cover are calculated according to the smart mobile device design, size and operating parameters.

13. The method for wireless power transmission to a smart mobile device of claim 1, further including the steps of selecting the transmitter to send pockets of energy to the receiver when the smart mobile device comes within a predetermined charging range of the transmitter; verifying a battery charge level of smart mobile device; and powering or charging the smart mobile device to a full battery charge level.

14. The method for wireless power transmission to a smart mobile device of claim 11, wherein the cover with the receiver is a laptop cover, camera cover, GPS cover, a tablet cover or an iPod cover.

15. The method for wireless power transmission to a smart mobile device of claim 1, wherein the computer system transmitter includes adaptive pocket-forming for dynamically adjusting pocket-forming to regulate power on the receiver of at least one peripheral electronic device within predetermined range of the transmitter through communication signals between the transmitter and receiver communication circuitry.

16. A receiver for wireless power transmission to a smart mobile device, comprising:
a flexible housing of a predetermined configuration mounted on the smart mobile device;
an array of antenna elements spaced apart a predetermined distance from one another around the flexible housing for optimal reception of power RF waves in the form of pockets of energy generated by a pocket-forming transmitter; and
a rectifier connected to a power convertor for converting the pockets of energy into a charging or powering voltage for the smart mobile device.

17. The receiver for wireless power transmission to a smart mobile device of claim 16, wherein the flexible housing is a flexible printed circuit board connected to the antenna elements, rectifier and power converter.

18. The receiver for wireless power transmission to a smart mobile device of claim 16, wherein the antenna elements are printed antenna elements on the flexible housing for collecting the power RF waves for charging the smart mobile device.

18. The receiver for wireless power transmission to a smart mobile device of claim 16, wherein the power converter is a DC-DC converter to provide a constant voltage output to the smart mobile device.

19. The method for wireless power transmission to an electronic device from a computer system of claim 16, wherein the flexible housing includes a flexible cable for connection to a battery in the smart mobile device and provides a cover for a smartphone, iPad, iPod, tablet, a laptop computer, a camera, a GPS unit or other such smart mobile device requiring battery power.

20. The receiver for wireless power transmission to a smart mobile device of claim 16, wherein the antenna elements spaced apart a predetermined distance from each other and are facing out from an inner surface of the flexible housing when used as a cover for the mobile device and the antenna elements are facing out from the outer surface of the flexible housing when embedded around an internal edge of the smart mobile device for optimum reception of the power RF waves.
